(19) United States
(12) Patent Application Publication
(10) Pub. No.: US 2010/0124668 A1
(43) Pub. Date: May 20, 2010

(54) Composite aluminum tread plate sheet

(76) Inventors: Alok Kumar Gupta, Kingston (CA); Barney I. Costello, Painesville, OH (US); David Michael Custers, Inverary (CA)

Correspondence Address: Christopher C. Dunham;c/o Cooper & Dunham LLP, 20th Floor, 30 Rockefeller Plaza, New York, NY, 10112, US

(21) Appl. No.: 12/590,566

(22) Filed: Nov. 10, 2009

Related U.S. Application Data
(60) Provisional application No. 61/199,281, filed on Nov. 14, 2008.

(51) Int. Cl. B32B 15/01

(52) U.S. Cl. 428/654

(57) ABSTRACT

The invention relates to a tread plate product having an aluminum composite structure. The structure includes a core layer and at least one clad layer, wherein the core layer is an alloy of the AA5XXX series alloys in which the Mg content is 2% by weight or more and the clad layer(s) is made of an alloy of the AA3XXX series or AA5XXX series alloys, in which the Mg content is 1% by weight or less. The structure may be made in thin gauge while retaining or enhancing desirable mechanical properties.

### CROSS-REFERENCE TO RELATED APPLICATIONS

This application claims the priority right of prior U.S. provisional patent application Ser. No. 61/199,281 filed Nov. 14, 2008 by applicants named herein. The entire contents of the aforesaid provisional patent application are incorporated herein by this reference.

### BACKGROUND OF THE INVENTION

(1) Field of the Invention

The present invention relates to tread plate sheets. More particularly, the invention relates to tread plate sheets made of aluminum alloys.

(2) Description of the Related Art

Tread plate is metal sheet with a regular pattern of raised or embossed features on at least one surface. It is commonly used in a diverse range of applications. The raised or embossed features are commonly narrow diamond shapes and three-bar or five-bar shapes, although many possibilities exist for such raised features, both in individual design and the pattern in which they appear on the sheet. A principal use is for non-slip flooring and steps but it is also used in machinery applications, as the walls of tool boxes, as running boards for flat bed pick-up trucks, and as decorative trim, amongst others. In all of these applications the sheet needs to possess sufficient mechanical stability and the surface appearance may be bright, semi-bright or mill finish quality, depending on customer or design requirements. Although weight is not always a factor, there are applications (e.g. in the automotive industry) when aluminum tread plate is more desirable than steel tread plate because it is lighter. In addition there are a few applications, such as tool boxes, where reasonable formability is required as well as mechanical stability and good appearance. Whilst some prior art sheet meets the formability requirements they lack the higher strengths that would enable gauge reductions required to save weight.

Currently aluminum tread plate is made from monolithic alloy sheets using aluminum alloys such as AA6061, AA3003, AA5086, AA5052, AA5083, AA3005, AA6063 and AA8011. For an understanding of the number designation system most commonly used in naming and identifying aluminum and its alloys see “International Alloy Designations and Chemical Composition Limits for Wrought Aluminum and Wrought Aluminum Alloys”, published by The Aluminum Association, revised January 2001 (the disclosure of which is incorporated herein by reference).

Composite materials or clad materials are known within the aluminum industry to and find uses in applications in aerospace or as brazing sheet. In brazing sheet, the core alloy is typically an alloy from the AA3XXX series of alloys and, typically, the clad layer is an AA4XXX series alloy. The main alloying element in an AA3XXX series alloy is manganese and in an AA4XXX series alloy the main alloying element is silicon. The lower melting point of the AA4XXX series alloy allows the brazing sheet to be brazed to other components such as fins or tubes. In aerospace, combinations of AA2XXX series alloys as the core alloy (with copper as the main alloying element) with an AA1XXX series as the clad layer are widely used. Combinations of AA6XXX series alloys in the core layer with AA7072 are also known for use as fuselage sheet.

There is a need for an aluminum tread plate sheet product which provides desirable mechanical properties whilst maintaining or improving formability performance and, through this combination, enables designers to use thinner gauge sheet and therefore to save weight and bulk.

### BRIEF SUMMARY OF THE EXEMPLARY EMBODIMENTS

One exemplary embodiment of the present invention provides a tread plate product which comprises an aluminum composite structure having a core layer and at least one clad layer, wherein the core layer is an alloy selected from the group of alloys consisting of the AA5XXX series alloys where the Mg content is 2% or more by weight of the alloy, and the at least one clad layer is selected from the group of alloys consisting of the AA3XXX series and AA5XXX series alloys where the Mg content is 1% by weight or less of the alloy. Preferably, the Mg content of the core alloy is >2% by weight of the alloy, and the Mg content of the at least one clad layer is <1% by weight of the alloy.

In one exemplary embodiment, the composite structure preferably comprises three layers with a core layer positioned between two clad layers. In such an embodiment, the two clad layers are preferably of the same composition, but may be different if desired.

In one exemplary embodiment, the composite product comprises just two layers, i.e. a core layer and a clad layer. In the normal use of the terms within the industry, the clad layer is usually the term given to that layer which dictates surface characteristics such as corrosion resistance or brightness. The core layer is usually the term given to the layer whose primary purpose is to influence the bulk mechanical properties of the overall sheet product. The clad layer is usually, but may not always be, thinner than the core layer. Clearly, in a three or more layer structure, the core layer is generally an internal layer, and is usually the central layer of a three layer structure.

In the exemplary embodiments, the alloys of the core layer are selected to be inherently stronger than the alloys used in the clad layer. For this reason, the Mg content of the AA5XXX series alloys suitable for use as a core layer is more than 2% by weight of Mg. The core alloy may be selected from the group consisting of AA5052, AA5083, AA5383, AA5086, AA5186, AA5154, AA5254, AA5454 and AA5754. The preferred 5XXX series core layer alloy is selected from the group consisting of AA5052, AA5056, AA5083 and AA5383. The most preferred AA5XXX series core layer alloy is AA5052.

The AA3XXX series alloys of the clad layer are preferably selected from the group consisting of AA3003, AA3005 and AA3105. The preferred AA3XXX series clad layer alloys is AA3003.

In the case where the clad layer is an AA5XXX series alloy, the Mg content is <1% by weight in order to provide the required bright surface finish. The preferred AA5XXX series alloy composition for the clad layer is selected from the group of alloys described as AA5X05, which includes AA5005 and AA5205. The most preferred AA5XXX series alloy for use in the clad layer is AA5005.

An optimised product according to this invention is a composite structure having a core layer of AA5052 and a clad layer of AA3003.

### BRIEF DESCRIPTION OF THE DRAWINGS

FIG. 1 of the accompanying drawings is a schematic cross-section of a tread plate having three layers illustrating one preferred form of the exemplary embodiments (the raised or embossed pattern having been omitted for the sake of simplicity); and

FIG. 2 is a perspective view of an exemplary embodiment of a tread plate to showing a diamond-shape repeating raised pattern.

### DETAILED DESCRIPTION OF THE EXEMPLARY EMBODIMENTS

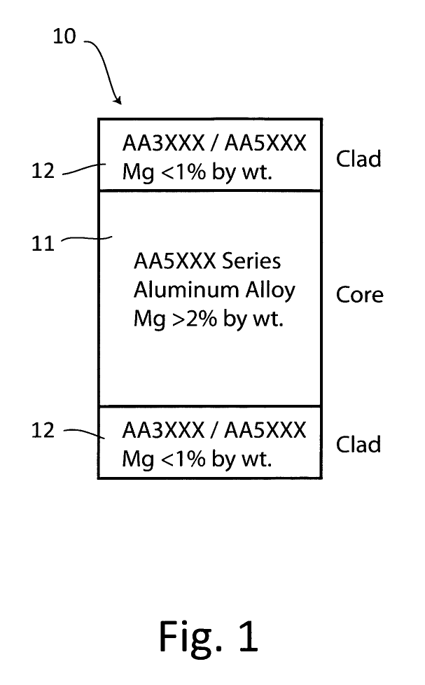

In the structure of FIG. 1, a tread plate 10 has a central core layer 11 and two surface clad layers 12. The alloys that may be chosen for the layers are shown in the drawing. Of course, one of the clad layers 12 may be omitted to provide a two-layer structure.

Products according to the exemplary embodiments can be fabricated by conventional methods known to those in the aluminum industry. For example, the products can be made by a traditional roll bonding approach where the layers are initially cast as separate ingots, homogenized and hot rolled to an intermediate thickness, then hot or cold rolled together to form the composite structure, followed by further rolling as necessary. As is known to the skilled person, various heat treatment steps may be incorporated within this process if necessary, such as but not limited to intermediate anneals or solution heat treatment.

An alternative method of manufacture involves casting the two or more layers at the same time or in the same casting operation to form a single ingot having distinct compositional layers. Such methods are also well known in the aluminum industry and are described by publications and patents such as international patent publications WO04/112992, WO98/24571, and WO03/035305 (the disclosures of which are incorporated herein by reference). The process according to WO04/112992 A2, which was published on Dec. 29, 2004 naming inventors Anderson et al., is best suited to manufacture of the products according to this invention because there is no need for the provision of an interlayer or permanent divider during casting. Once the composite ingot has been cast it can be processed in the conventional manner and process steps may include homogenization, hot and cold rolling, together with other standard manufacturing steps and heat treatments as deemed necessary by the skilled person.

The clad structures of the exemplary embodiments may be produced in the same gauge as conventional tread plate sheet (often 1.3 mm or more) used for the same purpose, but are preferably produced in thinner gauge to achieve a saving of weight. A gauge of less than 1.3 mm, or even 1.0 mm or less, is therefore able to be employed without significant loss of performance. Of course, the sheet may be made as thin as desired, provided the mechanical properties necessary for the selected purpose are achieved. The ratio of thickness of the core layer to the clad layer(s) is also optional. Generally, the clad layers are made thinner than the core (as mentioned above) and may be made as thin as desired, provided the required surface characteristics are achieved in the resulting sheet.

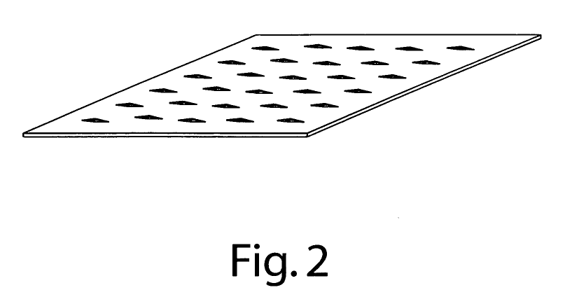

The sheet material thus produced can be provided with the raised or embossed features by any conventional method known to persons skilled in the art, e.g. by stamping, rolling, embossing, or the like. An example of a finished tread plate having diamond shaped raised patterns is shown in FIG. 2. The plate of FIG. 2 may have the composition shown in FIG. 1 or other composition according to the exemplary embodiments.

### EXAMPLES

The compositions of sheet product according to the exemplary embodiments are shown in Table 1, Sample 2, along with a monolithic alloy according to the prior art, Sample 1.

Both samples were initially DC cast, with the inventive product being cast according to the teaching of WO04/112992. They were then homogenized, hot rolled, cold rolled to final gauge and partially annealed according to standard practices within the industry to produce sheet in the H22 temper. Sample 1, the monolithic prior art example, was cold rolled to a gauge of 1.3 mm while Sample 2 was cold rolled to a gauge of 1.016 mm.

TABLE 1

| Sample | First clad | | Second clad |
|---|---|---|---|
| number | layer | Core layer | layer |
| 1 | No cladding | AA3003 | No cladding |
| 2 | AA3003 | AA5052 | AA3003 |

The tensile properties of both samples are shown in Table 2.1

TABLE 2.1

| Sample | Yield strength | Ultimate tensile | Elongation |
|---|---|---|---|
| number | (ksi) | strength (ksi) | (%) |
| 1 | 14.0 | 20.0 | 13.0 |
| 2 | 15.6 | 29.3 | 12.2 |

The formability of the samples was measured according to ASTM E290, semi-guided bend test for thin material. The formability results are shown in Table 2.2.

TABLE 2.2

| Sample | Bending |
|---|---|
| number | factor, r/t |
| 1 | 3 |
| 2 | 1.65 |

As noted, the gauge of Sample 1 was 1.3 mm while that of Sample 2 was 1.016 mm. If Sample 1 had been produced in a gauge of 1.016 mm like that of Sample 2, a bending factor lower than 3 would have been expected. However, a person skilled in the art would not have expected a bending factor as low as 1.65 as exhibited by Sample 2.

As described, the exemplary and preferred embodiments provide an increase in strength while at least maintaining the same bending performance, thus enabling the end user to achieve weight savings by using thinner sheet for the same purpose.

1. A tread plate product comprising an aluminum composite structure having a core layer and at least one clad layer wherein the core layer is an alloy selected from the group of alloys consisting of the 5XXX series alloys where the Mg content is 2% by weight or more and the at least one clad layer is selected from the group of alloys consisting of the 3XXX series and 5XXX series alloys where the Mg content is 1% by weight or less.

2. The product of claim 1 wherein the composite structure comprises two clad layers with one clad layer on each side of the core layer.

3. The product of claim 2 wherein the two clad layers are of the same composition.

4. The product of claim 1 wherein the at least one clad layer comprises an alloy selected from the group consisting of AA3003, AA3005 and AA3105.

5. The product of claim 1 wherein the clad layer is AA3003.

6. The product of claim 1 wherein the clad layer is an alloy selected from the group consisting of AA5005 and AA5205.

7. The product of claim 1 wherein the clad layer is AA5005.

8. The product of claim 1 wherein the core layer comprises an alloy selected from the group consisting of AA5052, AA5083, AA5383, AA5086, AA5186, AA5154, AA5254, AA5454 and AA5754

9. The product of claim 1 wherein the core layer is selected from the group consisting of AA5052, AA5056, AA5083 and AA5383.

10. The product of claim 1 wherein the core layer is AA5052.

11. The product of claim 1 having a thickness of less than 1.3 mm.

12. The product of claim 1 having a thickness of 1 mm or less.

13. The product of claim 1 having a regular pattern of raised or embossed features on at least one surface thereof.

14. A tread plate product comprising an aluminum composite structure having a core layer and at least one clad layer wherein the core layer is an alloy selected from the group of alloys consisting of the 5XXX series alloys where the Mg content is >2% by weight and the at least one clad layer is selected from the group of alloys consisting of the 3XXX series and 5XXX ( series alloys where the Mg content is <1% by weight.
